(19) United States
(12) Patent Application Publication
(10) Pub. No.: US 2015/0317058 A1
(43) Pub. Date: Nov. 5, 2015

(54) COMPUTER-IMPLEMENTED METHODS AND SYSTEMS FOR ORGANIZING INFORMATION IN THREE-DIMENSIONAL CONCEPT MAPS

(71) Applicant: AITOC, INC., Melrose, MA (US)

(72) Inventor: Uladzimir Babarykin, Melrose, MA (US)

(73) Assignee: AITOC, INC., Melrose, MA (US)

(21) Appl. No.: 14/703,451

(22) Filed: May 4, 2015

Related U.S. Application Data
(60) Provisional application No. 61/987,913, filed on May 2, 2014.

(51) Int. Cl. G06F 3/0481; G06F 3/0484; G06F 3/0482

(52) U.S. Cl. CPC G06F 3/04815; G06F 3/0482; G06F 3/04842

(57) ABSTRACT

Computer-implemented methods and systems enable users to systematically organize various kinds of information utilizing three-dimensional concept maps, in the form of graphical structures shown on a display of a user device. Such information organization enables exploitation of human visual and spatial memory as well as language metaphors and implicit associations generation to facilitate user understanding and memorization of a domain of knowledge.

### CROSS REFERENCE TO RELATED APPLICATION

This application claims priority from U.S. Provisional Patent Application No. 61/987,913 filed on May 2, 2014 entitled COMPUTER-IMPLEMENTED METHODS AND SYSTEMS FOR INFORMATION ORGANIZATION IN A THREE-DIMENSIONAL CONCEPT MAP, which is hereby incorporated by reference.

### BACKGROUND

The present application generally relates to visual and graphical representations of data on user computer devices. In particular, it relates to computer-implemented methods and systems that enable users to systematically organize various kinds of information utilizing three-dimensional concept maps, in the form of graphical structures shown on a display of the user device. Such information organization enables exploitation of human visual and spatial memory as well as language metaphors and implicit associations generation to facilitate user understanding and memorization of a domain of knowledge.

### BRIEF SUMMARY

In accordance with one or more embodiments, a computer-implemented information organization method is provided for specifying spatial relationships of information concepts in a graphical user interface structure using a set of primary directions (e.g., six directions—up/down, left/right, forwards/backwards) to a establish a fractal-like data structure. The method includes the steps of: (a) inputting information related to the first set of information objects, with the size of the set being up to six objects; (b) specifying spatial relationships between the elements of the first set of objects; (c) adding supporting information (e.g., text, images, links, videos, sounds, files and other objects) for the added objects; (d) decomposing any of the initial objects into a new set of up to six objects; (e) specifying spatial relationships between the elements of the decomposed set of objects; (f) specifying relationships between objects, sets of objects or objects and sets of objects as desired; and (g) adding/modifying/deleting information about the objects, the sets they belong to, their spatial orientation and relationships as desired.

In accordance with one or more embodiments, a computer data structure is provided for storing object information. The data structure comprises (a) information about sets of elements, each containing up to six objects; (b) information about the spatial relationships between the objects in each set of objects; (c) additional information for each of the objects; (d) information about parent/child relationships between objects and new sets of objects; and (e) information about other types of information about relationships between objects, sets of objects or objects and sets of objects.

In accordance with one or more embodiments, a graphical user interface is provided for displaying the spatial relationships between objects. The interface comprises (a) a cube with a view inside of it, showing five faces of the six available faces; (b) means to navigate within the cube—turn to various faces to have a better view of the needed faces or see the previously unseen one(s); (c) means to better orient in the space: cardinal directions, compass arrows, colors, etc.; (d) means to add/modify/delete objects to the six faces; (e) means to add/modify/delete additional information (e.g., text, images, links, videos, sounds, files and other objects) for the added objects on the faces; (f) means to add relationships between the supporting information and objects on one face as well as on different faces; and (g) means to decompose a face into a new cube and navigate to the new cube or back to the parent cube.

In accordance with one or more embodiments, the graphical user interface structure comprises a hexagon instead of a cube and the objects and their supporting information are added to either vertices or angles (depending on the hexagon type).

In accordance with one or more embodiments, the graphical user interface structure comprises a “flower of life” structure instead of a cube.

In accordance with one or more embodiments, the graphical user interface structure comprises an enumerated list instead of a cube.

In accordance with one or more embodiments, the graphical user interface structure comprises a hierarchical tree structure (mind map) instead of a cube.

In accordance with one or more embodiments, the graphical user interface structure comprises a color scheme comprising of six colors instead of a cube.

In accordance with one or more embodiments, the graphical user interface structure comprises an inside view of a hypercube instead of a cube.

In accordance with one or more embodiments, a graphical user interface is provided for displaying an outside panoramic view of the data structure. The interface comprises (a) detached fractal cubes that decrease in size at each level of decomposition; (b) objects and supporting information on faces of the cubes; (c) connections between cubes, objects, faces, supporting info of the objects where desired; (d) means to rotate and navigate the structure; and (e) means to add/edit/delete cubes, objects, faces, supporting info of the objects and links between them.

In accordance with one or more embodiments, the graphical user interface includes hypercubes instead of cubes.

In accordance with one or more embodiments, the same functions are performed by other types of fractal cubes.

In accordance with one or more further embodiments, information organization methods, data structures, and graphical user interfaces are provided with a varying number of spatial directions and relationships, as well as varying number of objects and their supporting information, using different 3D shapes to organize information.

In accordance with one or more embodiments, a computer-implemented information organization method is provided for specifying spatial relationships of objects (information concepts) using varying number of spatial directions using any convenient way to specify the directions (e.g., using names of primary directions: up/down, left/right, forwards/backwards; or any of their combinations, e.g., forwards+left, down+backwards; using polar and azimuth angles of a spherical coordinate system; using cardinal directions applied to primary planes; using clock positions and directions applied to primary planes). The method comprises the steps of: (a) inputting information related to the first set of objects, with the possibility to use varying size of the set; (b) specifying spatial relationships between the elements of the first set of objects; (c) adding supporting information (e.g., text, images, links, videos, sounds, files and other objects) for the added objects; (d) decomposing any of the initial objects into a new set of objects with the size of the child set being either equal to the size of the parent set, or having a different size; (e) specifying spatial relationships between the elements of the decomposed set of objects; (f) specifying relationships between objects, sets of objects or objects and sets of objects as desired; and (g) adding/modifying/deleting information about the objects, the sets they belong to, their spatial orientation and relationships as desired.

In accordance with one or more embodiments, a computer data structure is provided for storing information about objects. The data structure comprises (a) information about sets of elements, each containing a varying number of objects; (b) information about the spatial relationships between the objects in each set of objects; (c) additional information for each of the objects; (d) information about parent/child relationships between objects and new sets of objects; and (e) information about other types of information about relationships between objects, sets of objects or objects and sets of objects.

In accordance with one or more embodiments, a graphical user interface is provided for displaying the spatial relationships between objects. The interface comprises (a) a polyhedron (a solid in three dimensions) with a view inside of it, showing multiple faces. Some examples of the possible polyhedra are tetrahedrons, cubes, rectangular cuboids, prisms with any number of faces (pentagonal, hexagonal, octagonal, decagonal, dodecagonal, etc.), rhombicuboctahedrons, etc.; (b) means for the user to choose the particular form of the polyhedron; (c) means to navigate within the polyhedron: turn to various faces to have a better view of the needed faces or see the previously unseen one(s); (d) means to better orient in the space: compass arrows, colors, cardinal directions, etc.; (e) means to add/modify/delete objects to/on the faces; (f) means to add/modify/delete additional information (e.g., text, images, links, videos, sounds, files and other objects) for the added objects on the faces; (g) means to add relationships between the supporting information and objects on one face as well as on different faces; and (h) means to decompose a face into a new polyhedron (of equal or different size) and navigate to the new child polyhedron or back to the parent one.

In accordance with one or more embodiments, the graphical user interface comprises a polygon (e.g., triangle, quadrilateral, pentagon, hexagon, heptagon, octagon, decagon, dodecagon, hexadecagon, etc.) instead of a polyhedron and the objects and their supporting information are added to either vertices or angles (depending on the polygon type).

In accordance with one or more embodiments, the graphical user interface structure comprises an enumerated list instead of a polyhedron.

In accordance with one or more embodiments, the graphical user interface structure comprises a hierarchical tree structure (mind map) instead of a polyhedron.

In accordance with one or more embodiments, the graphical user interface structure comprises a color scheme comprising of multiple colors instead of a polyhedron.

In accordance with one or more embodiments, the graphical user interface structure comprises an inside view of a four-dimensional polytope (polychoron) instead of a polyhedron (e.g., a tesseract (four-dimensional hypercube, 4-cube) instead of a cube, tetrahedral hyperpyramid (5-cell) instead of a tetrahedron, duoprisms with varying amount of base polygons (e.g., 4-5 duporism, 4-6, duporism, 6-6 duoprism, 8-8 duoprism, etc.) instead of prisms, etc.).

In accordance with one or more embodiments, a graphical user interface is provided for displaying an outside panoramic view of the data structure. The interface comprises (a) detached fractal polyhedra of same or different shapes that decrease in size at each level of decomposition (parent-child relationships); (b) objects and supporting information on faces of the polyhedra; (c) connections between the polyhedra, objects, faces, supporting info of the objects where desired; (d) means to rotate and navigate the structure; and (e) means to add/edit/delete polyhedra, objects, faces, supporting info of the objects and links between them.

In accordance with one or more embodiments, the graphical user interface includes polytopes instead of polyhedra.

In accordance with one or more embodiments, the same functions are performed by other ways to show fractal polyhedra.

### BRIEF DESCRIPTION OF THE DRAWINGS

FIG. 1 is a screenshot showing an inside (first-person) view of an exemplary cube with information placed on the inside faces of the cube in accordance with one or more embodiments.

FIG. 2 is a screenshot showing an outside (third-person) view of an exemplary cube with information placed on the outside faces of the cube in accordance with one or more embodiments.

FIG. 3 is a screenshot showing an exemplary 3D fractal cubical network with low level of decomposition in accordance with one or more embodiments.

FIG. 4 is a screenshot showing an exemplary 3D fractal cubical network with a higher level of decomposition in accordance with one or more embodiments.

FIG. 5 is a screenshot showing an exemplary 3D fractal cubical network with an even higher level of decomposition in accordance with one or more embodiments.

FIG. 6 is a screenshot showing an exemplary 3D fractal cubical network with more cubes decomposed to the next level in accordance with one or more embodiments.

FIG. 7 is a screenshot showing an exemplary 3D fractal cubical network with many cubes decomposed to the next level and a different zoom level in accordance with one or more embodiments.

FIG. 8 schematically illustrates an alternative method of organizing a data structure using a conventional tree diagramming/mind mapping tool in accordance with one or more embodiments.

FIG. 9 schematically illustrates yet another alternative method to organizing the data structure using lists in accordance with one or more embodiments.

FIG. 10 schematically illustrates a hypercube that can be alternatively used to organize the data structure in accordance with one or more embodiments.

FIG. 11 shows a flower of life by Leonardo Da Vinci, which contains a fractal 6-elements plus center structure that can be used as an alternative method for storing the data in accordance with one or more embodiments.

FIG. 12 shows another flower of life drawing that can be used in a similar way as Leonardo's flower of life as another alternative method for storing the data in accordance with one or more embodiments.

FIG. 13 is a screenshot showing an inside (first-person) view of an exemplary hexagonal prism with each of its faces containing information in accordance with one or more embodiments.

FIG. 14 is a screenshot showing an outside (third-person) view of an exemplary hexagonal prism with each of its faces containing information in accordance with one or more embodiments.

FIG. 15 is a screenshot showing an outside (third-person) view of an exemplary hexagonal prism (parent polyhedron) with each of its faces decomposed into new hexagonal prisms (child polyhedra) in accordance with one or more embodiments.

FIG. 16 is a screenshot showing an outside (third-person) view of an exemplary hexagonal prism (parent polyhedron) with eight of its faces decomposed into new hexagonal prisms (child polyhedra). Each of the child polyhedra serves as a parent polyhedron to six child polyhedra of lower level of decomposition in accordance with one or more embodiments.

FIG. 17 is a screenshot showing an inside (first-person) view of an exemplary octagonal prism with each of its faces containing information in accordance with one or more embodiments.

FIG. 18 is a screenshot showing an outside (third-person) view of an exemplary hexagonal prism with each of its faces containing information in accordance with one or more embodiments

FIG. 19 is a screenshot showing an outside (third-person) view of an exemplary octagonal prism (parent polyhedron) with each of its faces decomposed into new octagonal prisms (child polyhedra) in accordance with one or more embodiments.

FIG. 20 is a screenshot showing an outside (third-person) view of an exemplary octagonal prism (parent polyhedron) with eight of its faces decomposed into new octagonal prisms (child polyhedra). Each of the child polyhedra serves as a parent polyhedron to eight child polyhedra of lower level of decomposition in accordance with one or more embodiments.

FIG. 21 is a screenshot showing an inside (first-person) view of an exemplary rhombicuboctahedron with each of its faces containing information in accordance with one or more embodiments.

FIG. 22 is a screenshot showing an outside (third-person) view of an exemplary rhombicuboctahedron with each of its faces containing information in accordance with one or more embodiments.

FIG. 23 is a screenshot showing an outside (third-person) view of an exemplary rhombicuboctahedron (parent polyhedron) with most of its faces decomposed into new rhombicuboctahedra (child polyhedra) in accordance with one or more embodiments.

FIG. 24 is a screenshot showing an outside (third-person) view of an exemplary parent polyhedron (octagonal prism) with most of its faces decomposed into new child polyhedra of different shapes in accordance with one or more embodiments.

FIG. 25 is a screenshot showing an outside (third-person) view of an exemplary parent polyhedron (octagonal prism) with most of its faces decomposed into new child polyhedra of different shapes. One of the child polyhedra is also decomposed into new child polyhedra of different shapes, and the decomposition process is repeated one more time in accordance with one or more embodiments.

FIG. 26 is a simplified block diagram illustrating an exemplary computer system in which the methods and systems for organizing information may be implemented.

### DETAILED DESCRIPTION

Briefly and as will be described in further detail below, various embodiments disclosed herein are directed to computer-implemented methods and systems to assist users in organizing spatial relationships between information objects, in particular, between concepts of a field of knowledge. Organizing concepts using spatial relationships helps to turn on implicit embodied cognition of human beings and activates built-in human languages metaphors, serving as a basis for forming many other types of relationships and associations—semantic, grammatical, logical, etc. These phenomena combined with visual and verbal memory result in a high level of memorization of a concept and it's components. In accordance with one or more embodiments, six primary directions (up/down, left/right, forwards/backwards) are used as the basis for organizing relationships between components of a concept. Each component can be further decomposed into six subcomponents corresponding to the six major directions. The process can be further continued as desired.

In accordance with one or more embodiments, the number of spatial directions can be varied using any convenient way to specify the directions (using names of primary directions: up/down, left/right, forwards/backwards; any of their combinations, e.g., forward+left, down+backwards; using polar and azimuth angles of a spherical coordinate system; using cardinal directions applied to primary planes; using clock positions and directions). The spatial directions are used as the basis for organizing relationships between components of a concept. Each component can be further decomposed into new components with spatial relationships between them. The process can be further continued as desired.

The result of this decomposition process is a network of concepts. Additional relationships can be added to explicitly show various types of relationships. All this results in creation of a concept network with spatial relationships serving as the basis to aid people in storing large amounts of various implicit associations and relationships, as well as some explicit ones. This resulting concept network is very easy to remember for the person who created it.

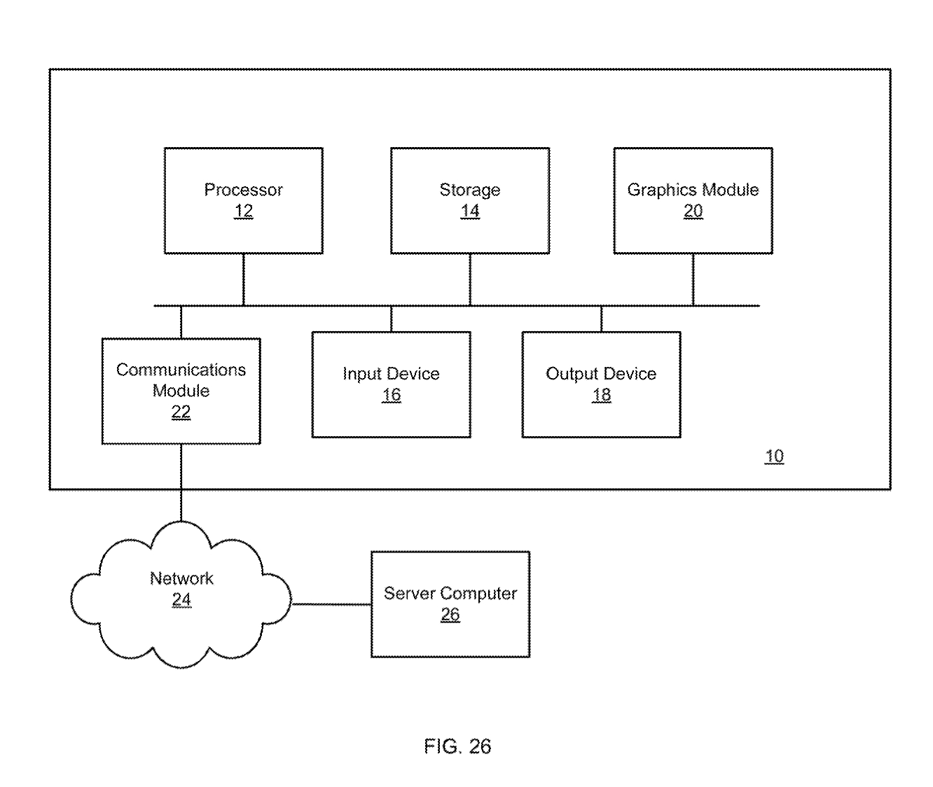

The processes for organizing information described herein are computer-implemented and may be implemented in software, hardware, firmware, or any combination thereof. The processes are preferably implemented in one or more computer programs executing on a programmable computer system 10 shown, by way of example, in the simplified block diagram of FIG. 26. The computer system 10 includes at least one computer processor 12, a storage system 14 readable by the processor (including, e.g., volatile and non-volatile memory and/or storage elements), an input and output devices 16, 18. Output devices include a display providing a graphical user interface. Input devices may include a keyboard and a mouse, touchpad or touchscreen for manipulating graphical elements on the display. The computer system 10 also includes a graphics module 20 for generating graphical elements. The computer system 10 may also include a network interface 22, which manages communication with a remote computer server 26 or other devices via telecommunications and other networks 24. The computer system can comprise, without limitation, personal computers (including desktop, notebook, and tablet computers), smart phones (e.g., the Apple iPhone and Android-based smart phones), wearable computer devices (e.g., smart watches and smart glasses), cell phones, personal digital assistants, and other mobile devices.

Each computer program can be a set of instructions (program code) in a code module resident in the random access memory of the computer system. Until required by the computer system 10, the set of instructions may be stored in another computer memory (e.g., in a hard disk drive, or in a removable memory such as an optical disk, external hard drive, memory card, or flash drive) or stored on another computer system 10 and downloaded via the Internet or other network 24. The processes may also be implemented in one or more computer programs executing on the remote computer server system 26, which communicates with computer system 10 operated by users over the computer network 24.

The computer system offers users graphical user interfaces to organize and access information. In accordance with one or more alternate embodiments, the system offers users two primary graphical user interfaces: a view inside of a polyhedron and an outside view of a fractal polyhedra structure. In accordance with one or more particular embodiments, the two primary graphical user interfaces comprise a view inside of a cube and an outside view of a fractal cubical structure. Other user interfaces with some limitations imposed on them (related to storing data in different directions) can be also used including, e.g., (enumerated) lists, hierarchical trees/mind maps, hypercubes, “flowers of life”, hexagons, polygons, etc.

In these cases, the system provides data structures for storing the needed information in a way to obtain the benefits described herein.

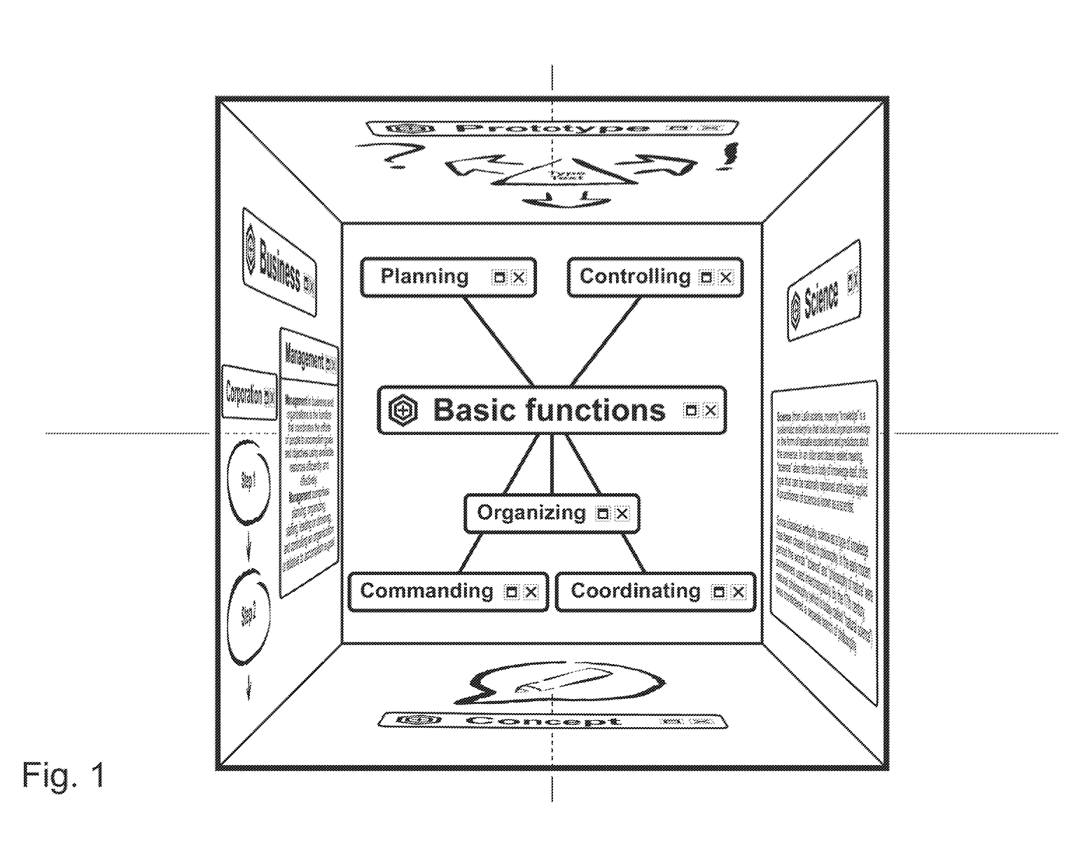

FIG. 1 illustrates a view inside of an exemplary cube for organizing information in accordance with one or more embodiments. Users can relate subcomponents of a concept and needed supporting information to major directions, which correspond to the faces of the cube. The process of relating faces with directions is generally intuitive for people.

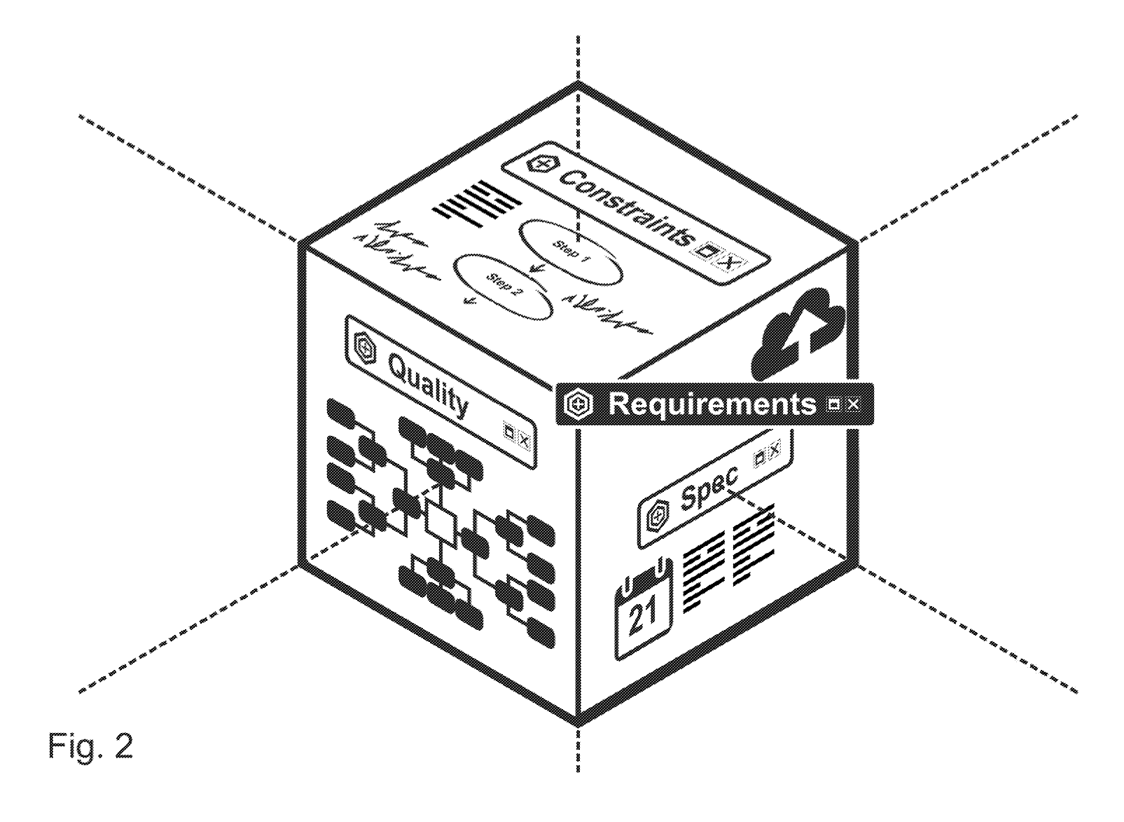

Users can use the computer graphical user interface to navigate around the sides of the cube by turning the cube to see the different faces of the cube. Users can select particular sides on which to enter information. Alternatively, users can place supporting information (e.g., text, images, links, videos, sounds, files and other objects) of subcomponents on outside faces of a cube as shown, e.g., in FIG. 2.

When in the inside of a cube view (FIG. 1), users place the subcomponents of information sought to be organized on the faces of the cube and organize the information in accordance with various relationships that are applicable to them. Each cube comprises a concept, with information on faces being subcomponents/subconcepts and supporting information for the subcomponents/subconcepts. Each of the faces of the cube can be further decomposed and become a new cube to provide a way to describe the concept in more detail.

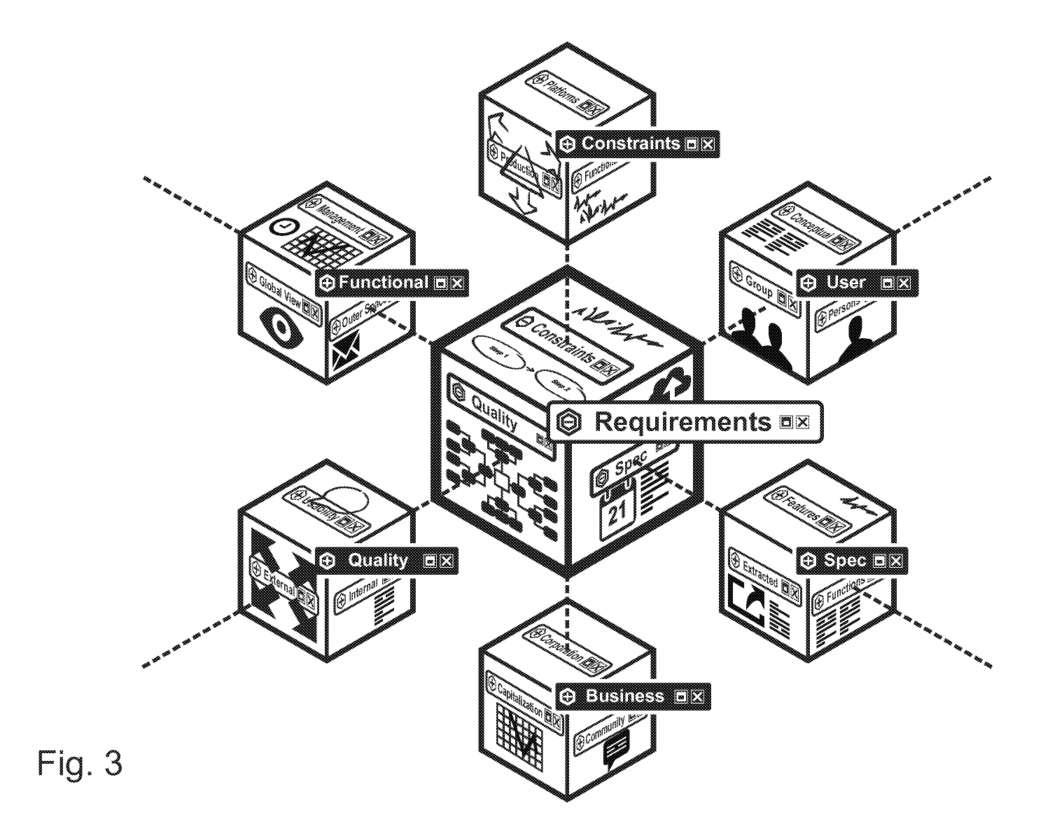

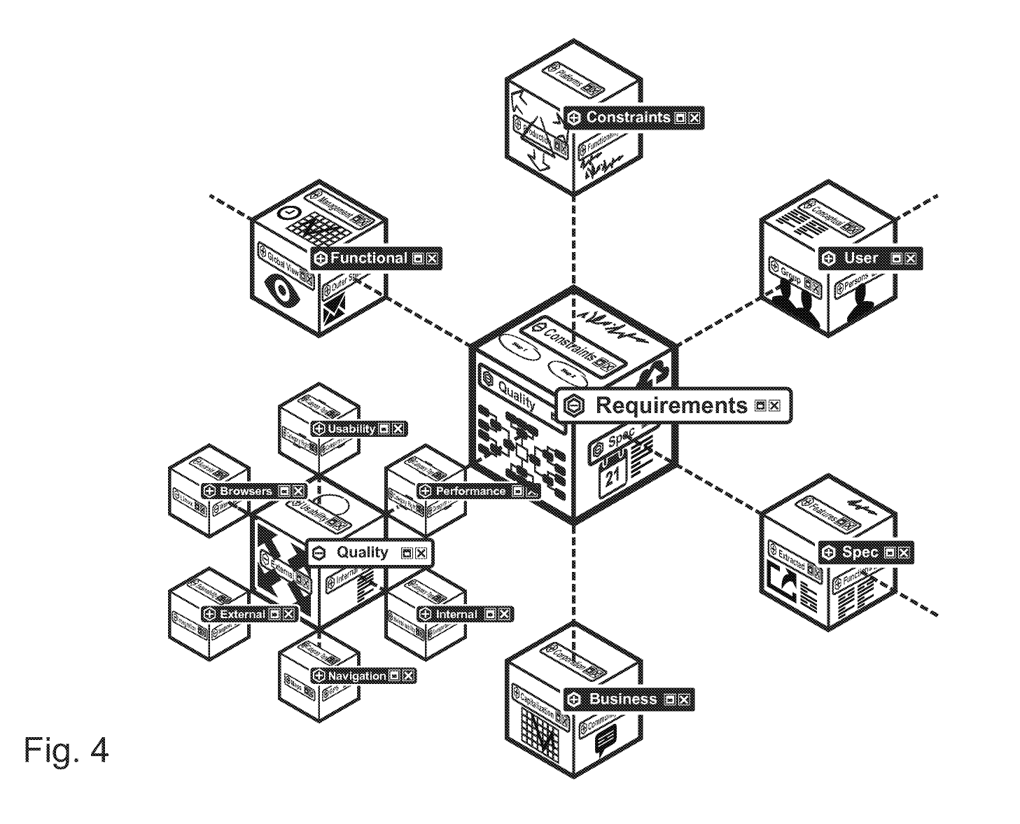

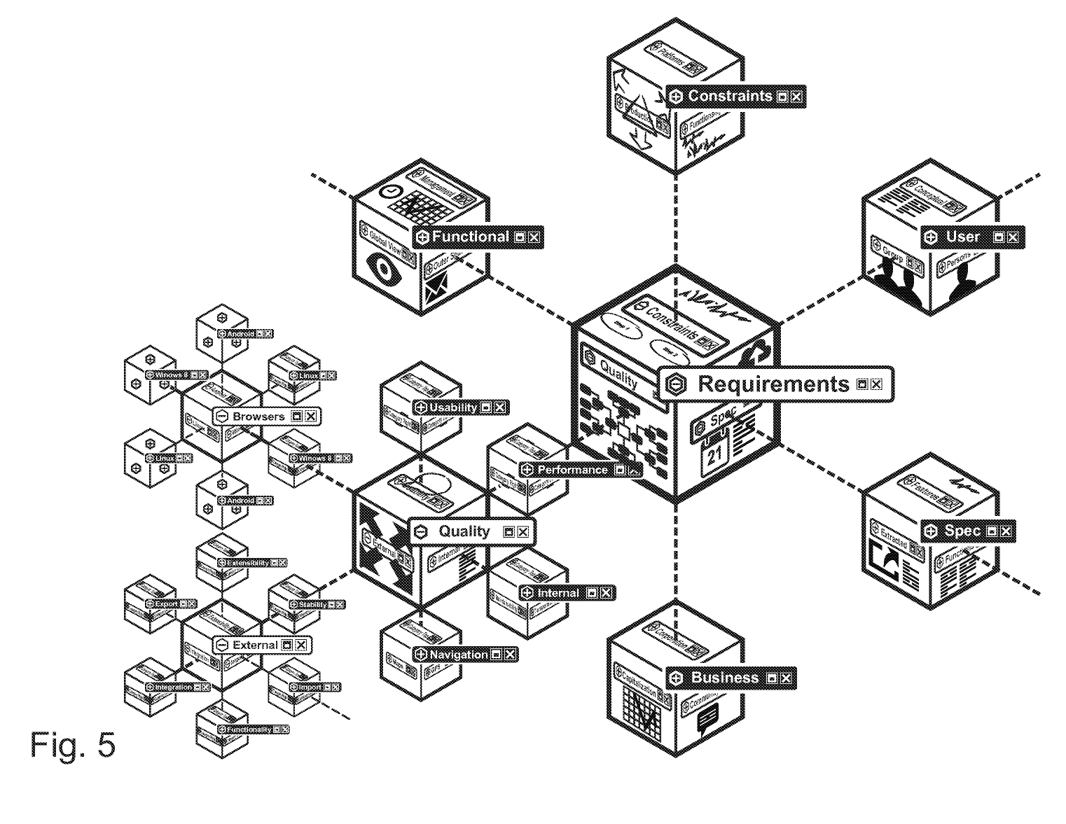

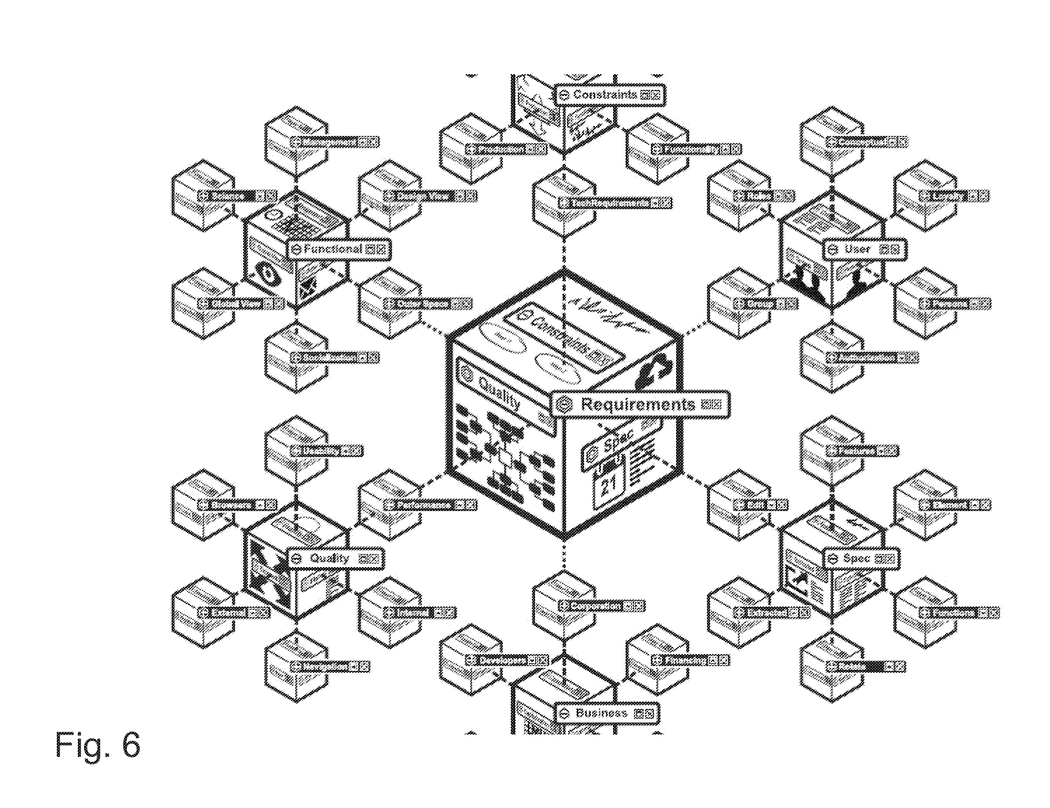

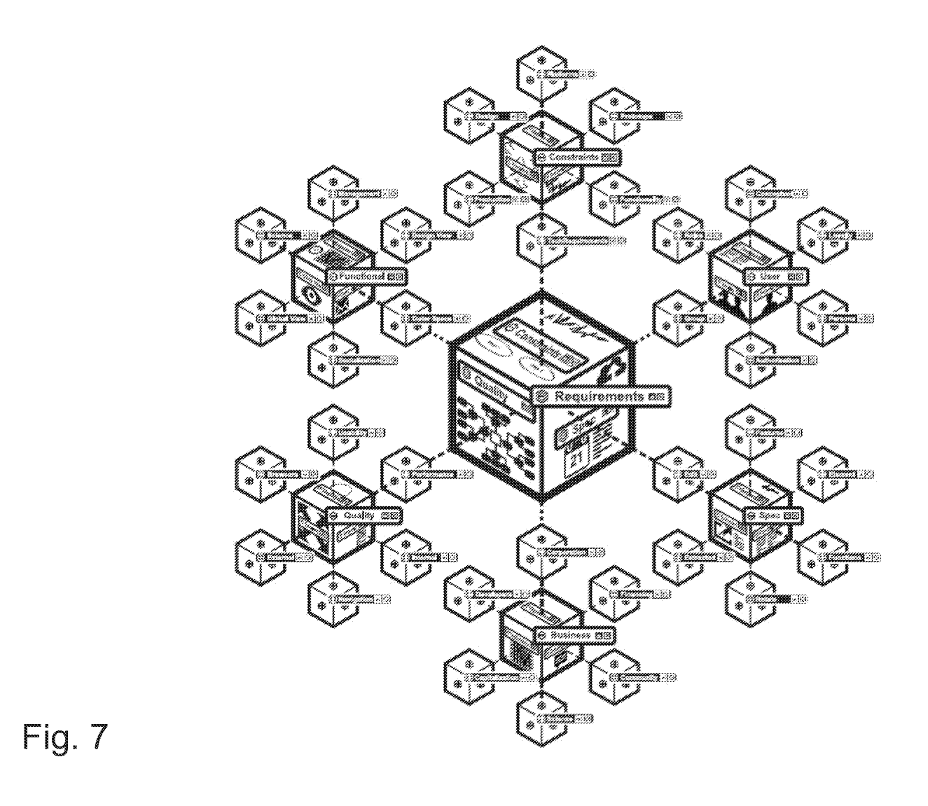

Another view is an outside cube view of the whole resulting cube structure as shown, e.g., in FIGS. 3-7, depicting the network as a fractal cubical structure. In order not to lose one of the directions for further use, the cubes are shown in such a way that each cube of the next level is shown detached from the parent cube and smaller in size. The resulting network (if all the faces are filled) has high resemblance with a third analogue of a Vicsek fractal, though with some differences. This view provides unique visibility and access to all the information as well as is a good resemblance of what people actually imagine if they decompose each cube into six directions. This view helps to further explore the structure created in the major view, or can serve as an alternative way to create it. Furthermore, it provides a good way to get away from the details and get a more global perspective of the system or field under study.

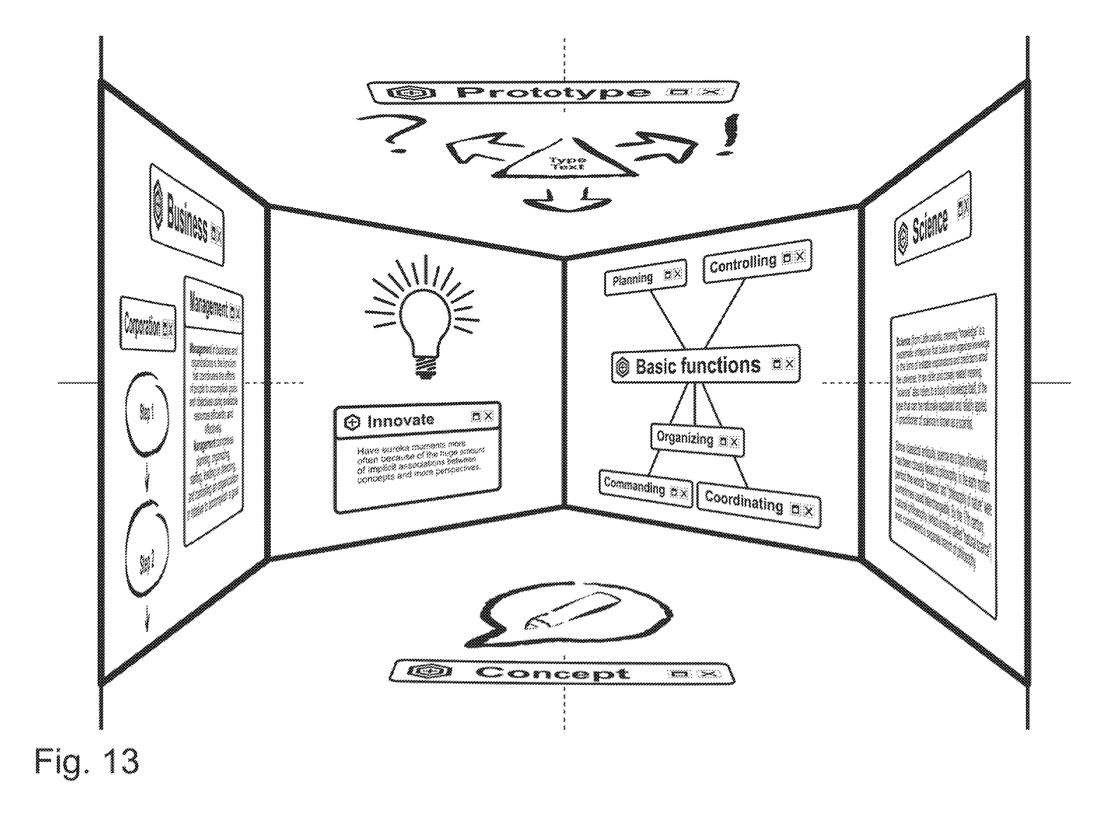

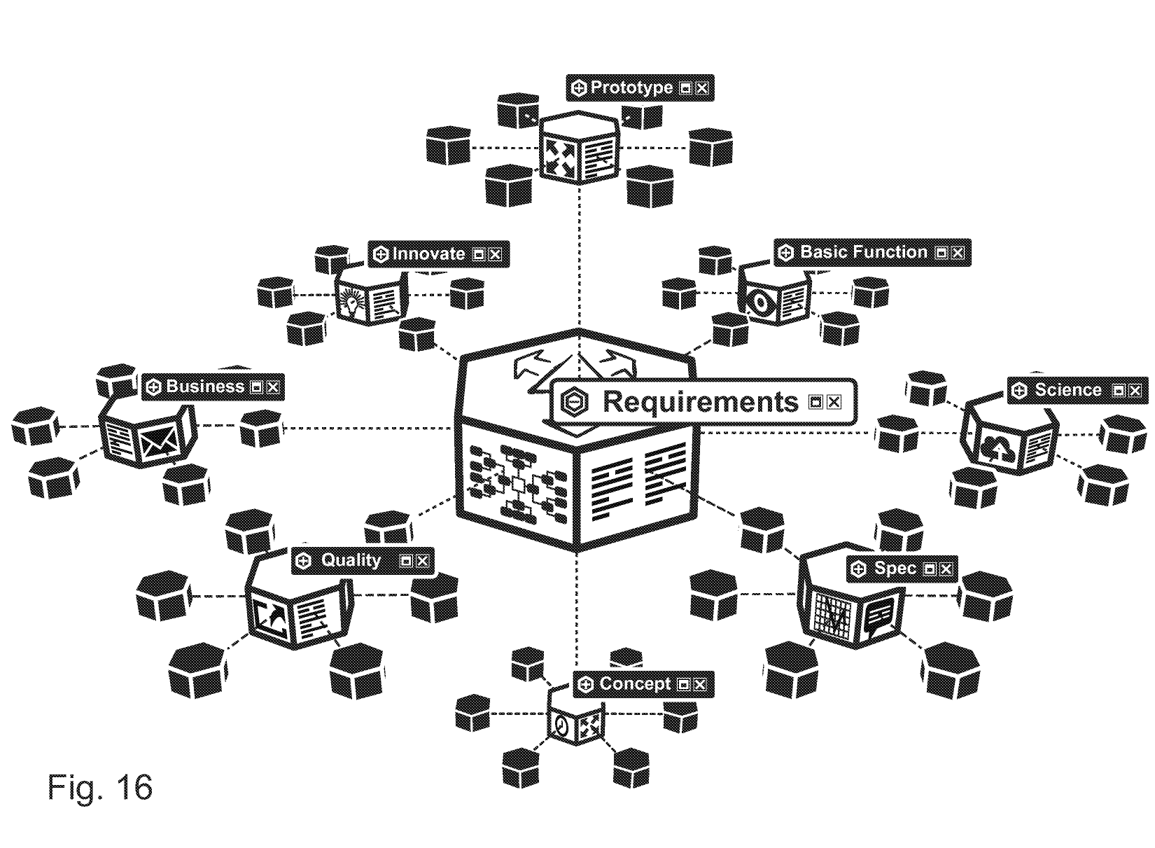

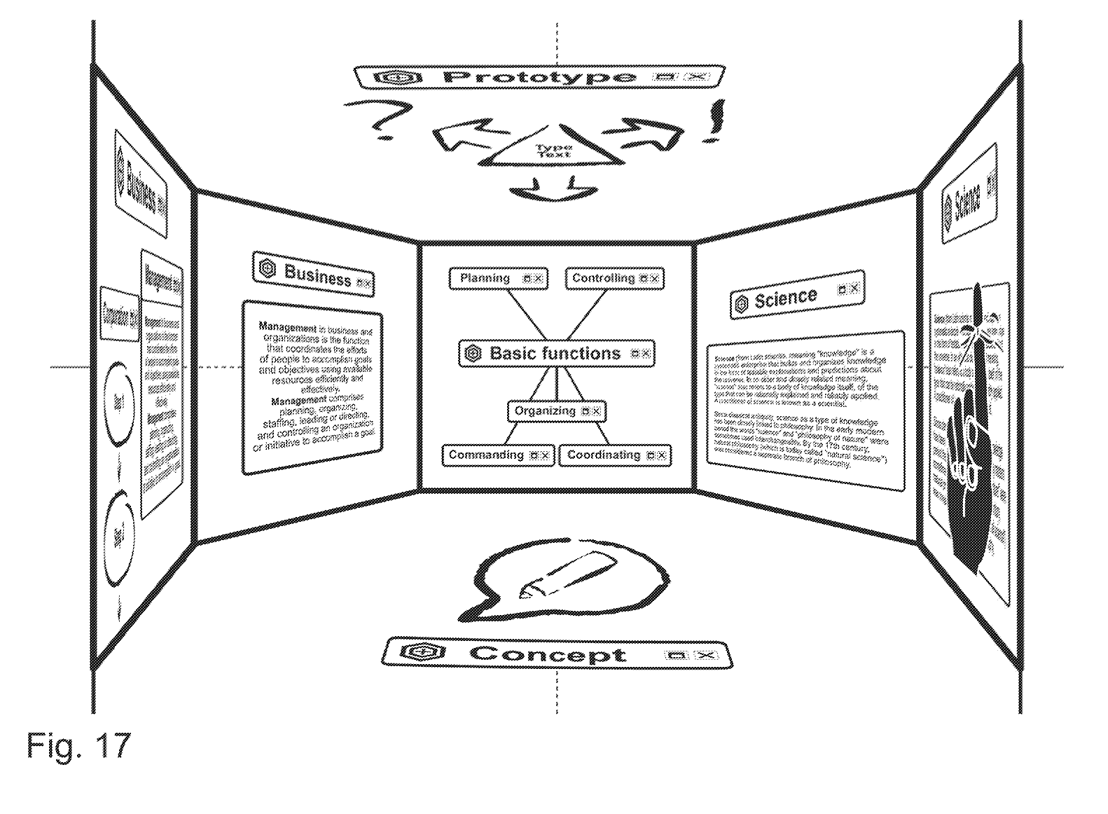

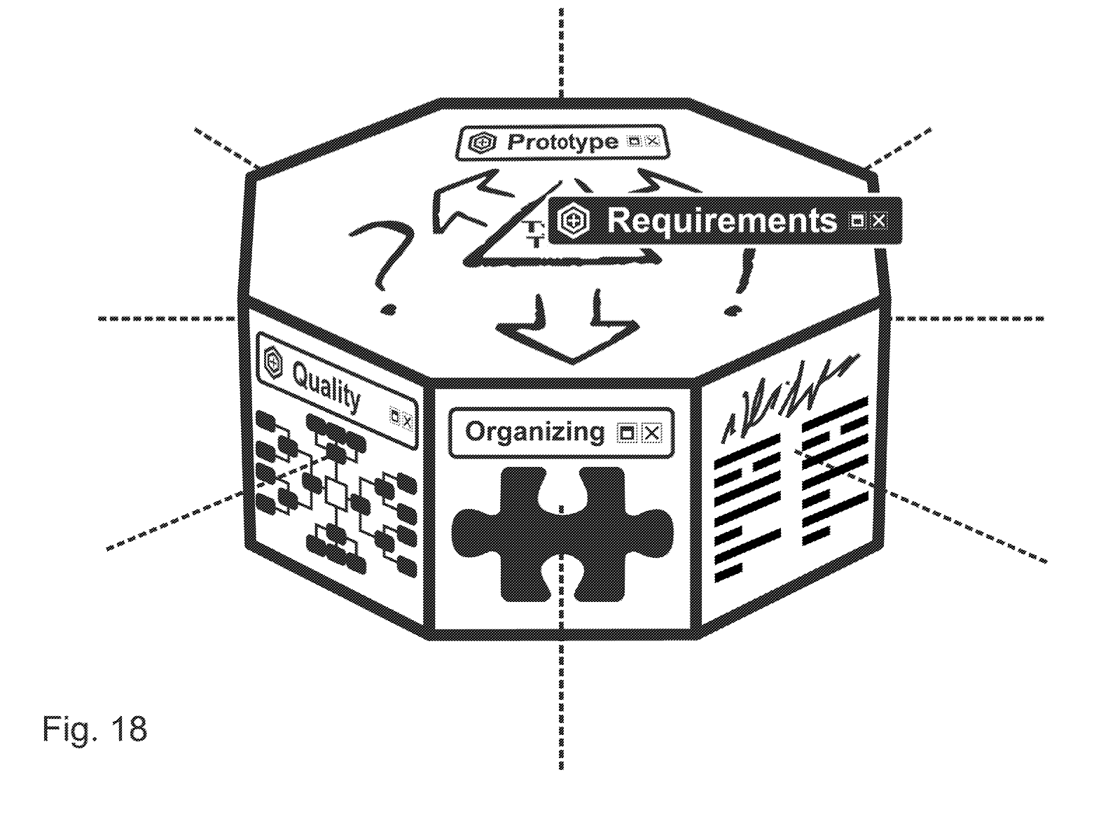

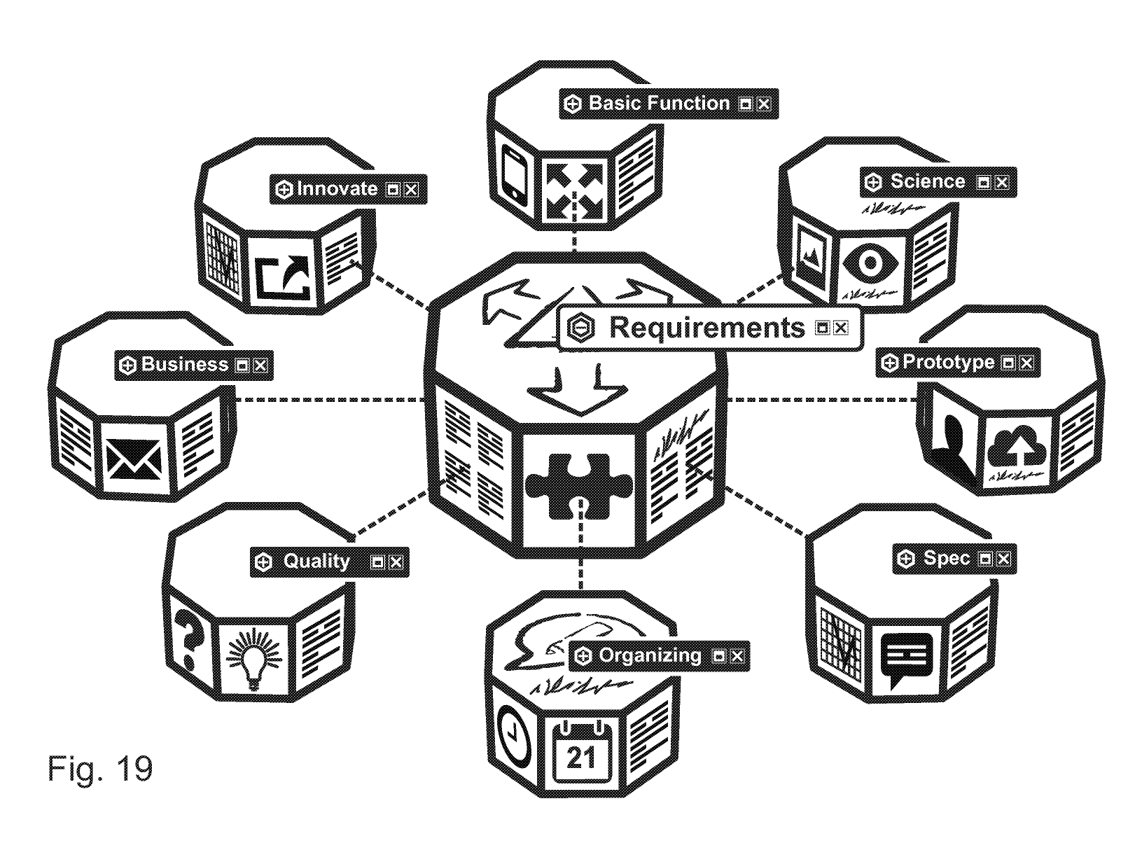

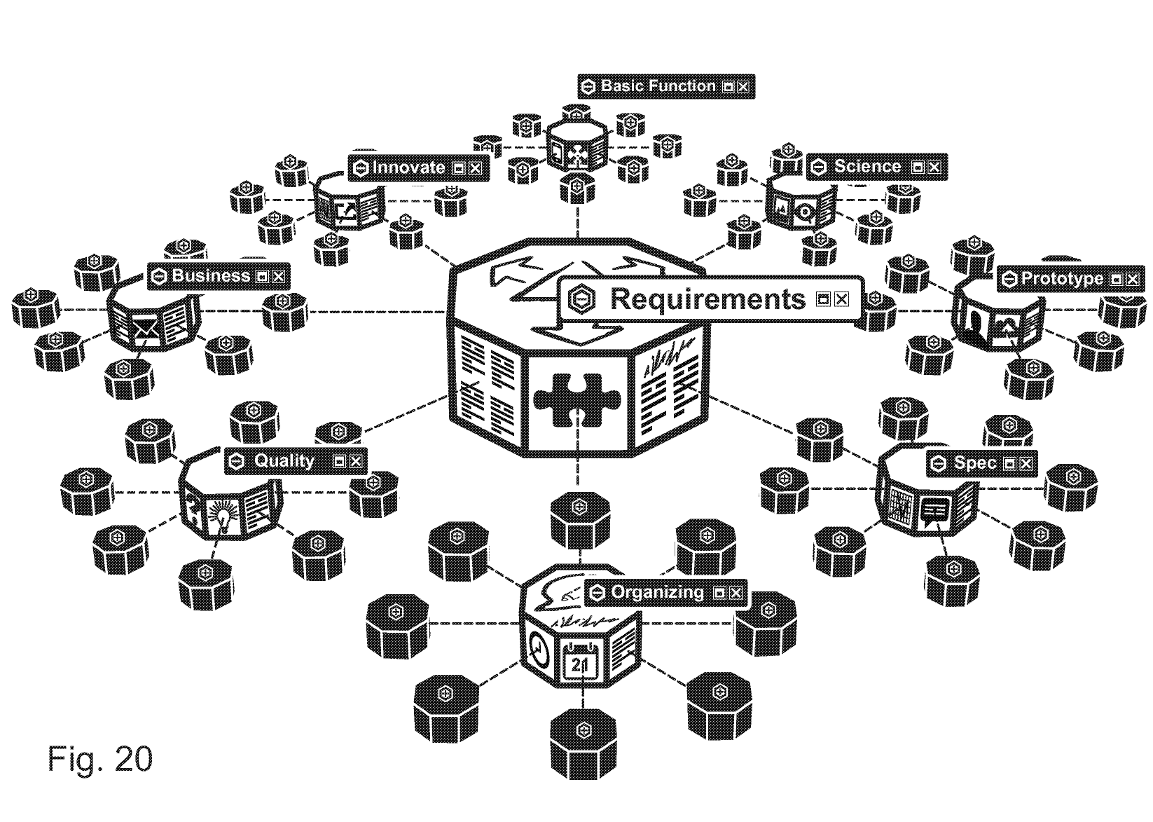

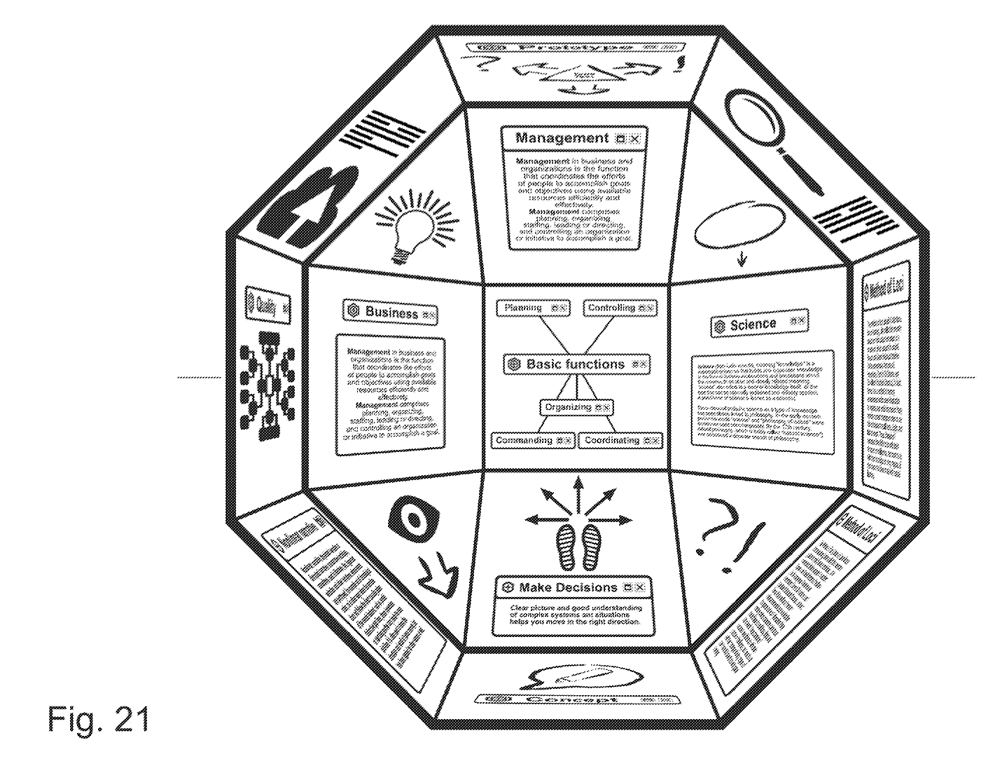

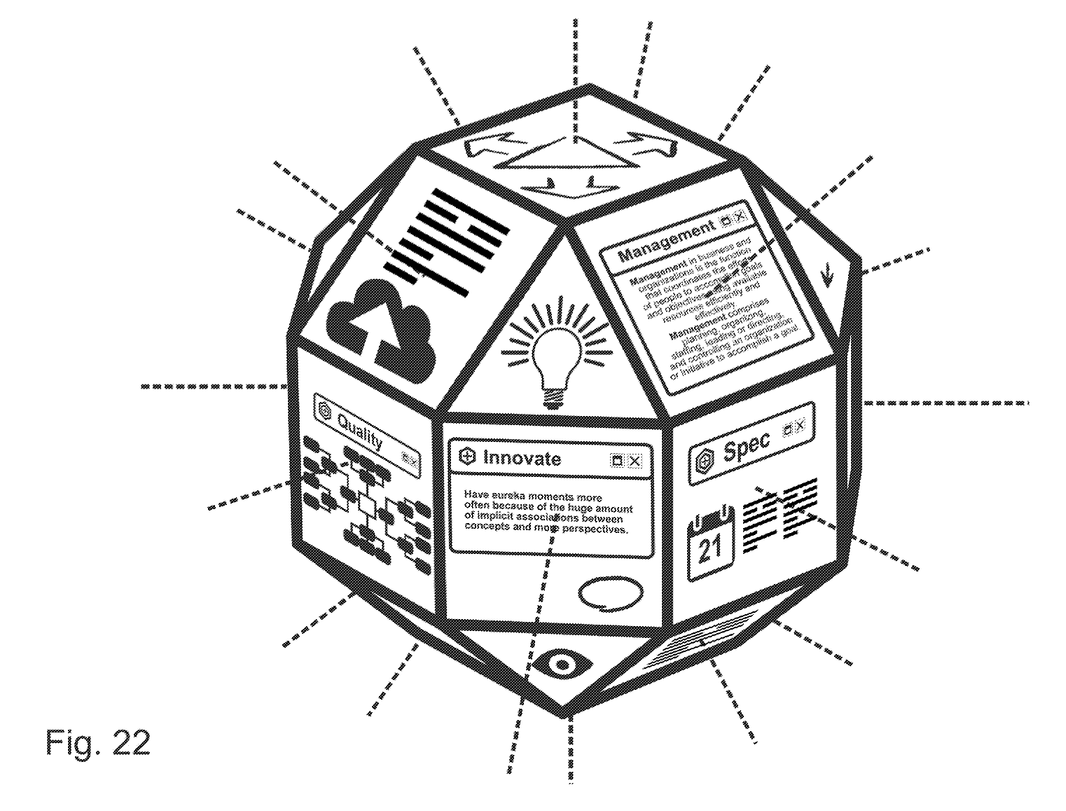

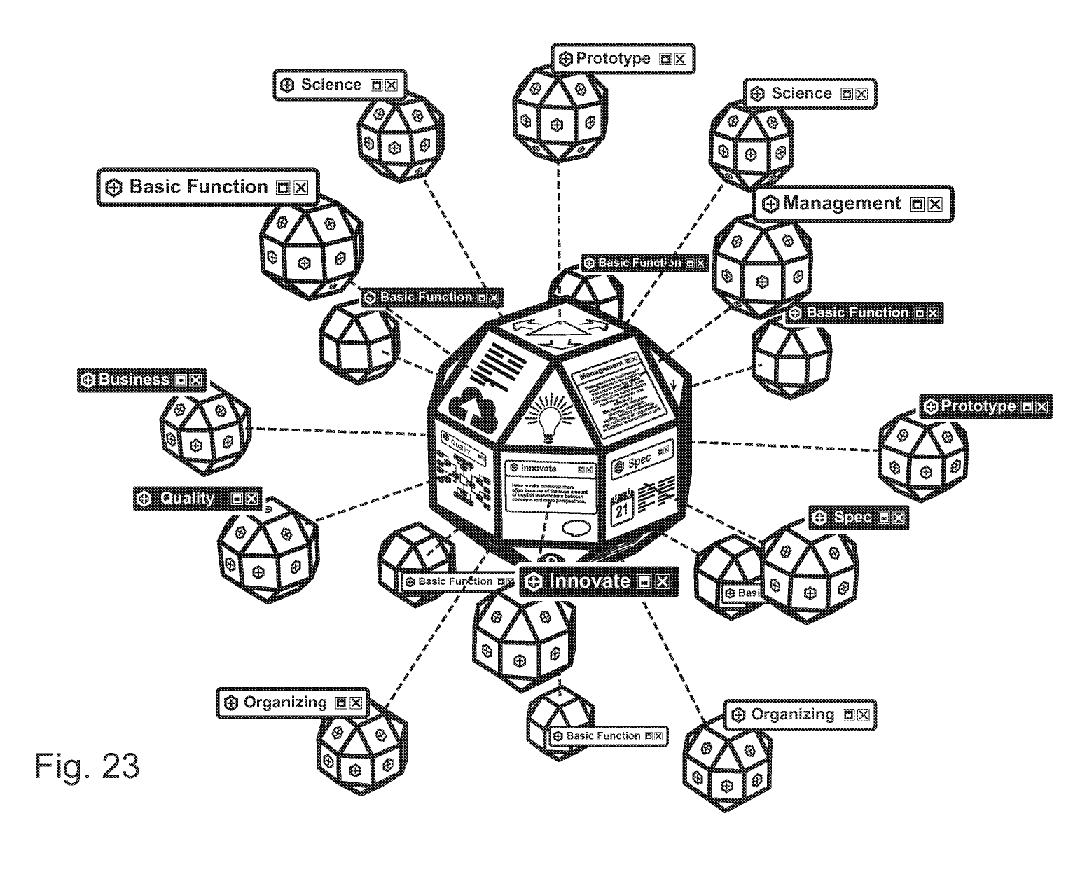

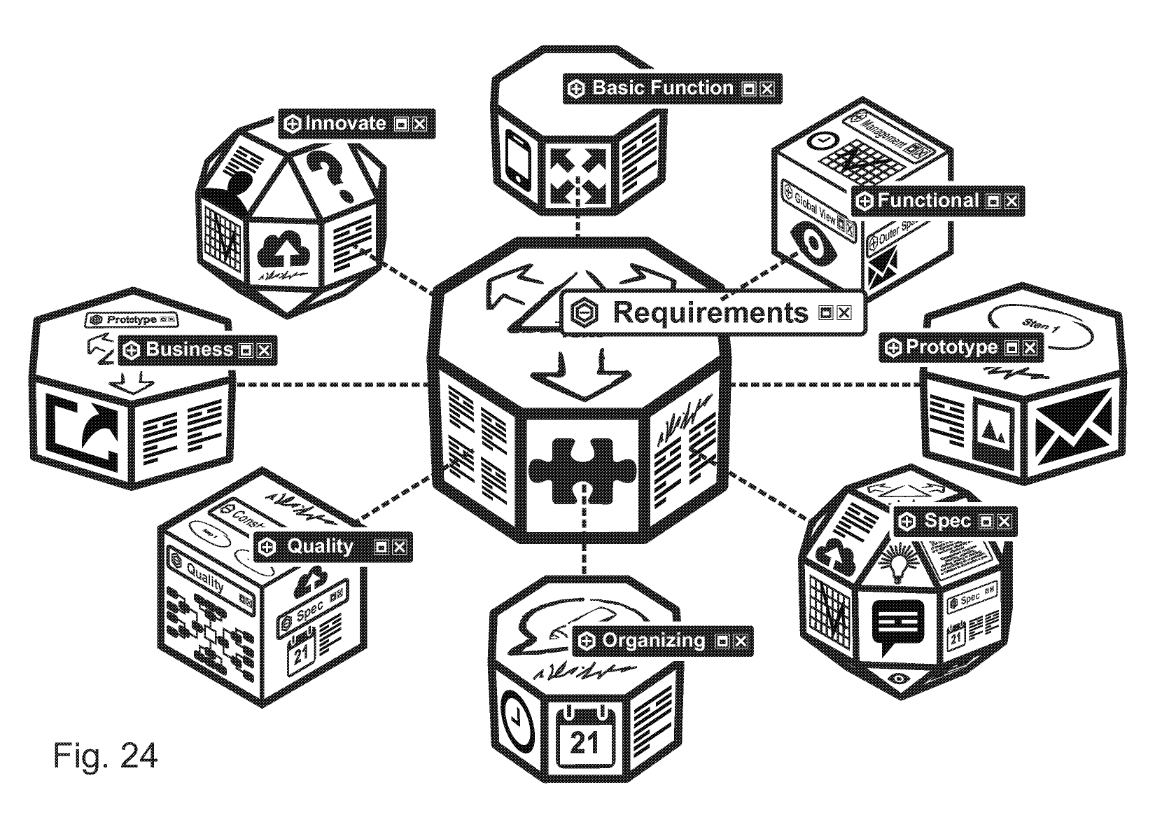

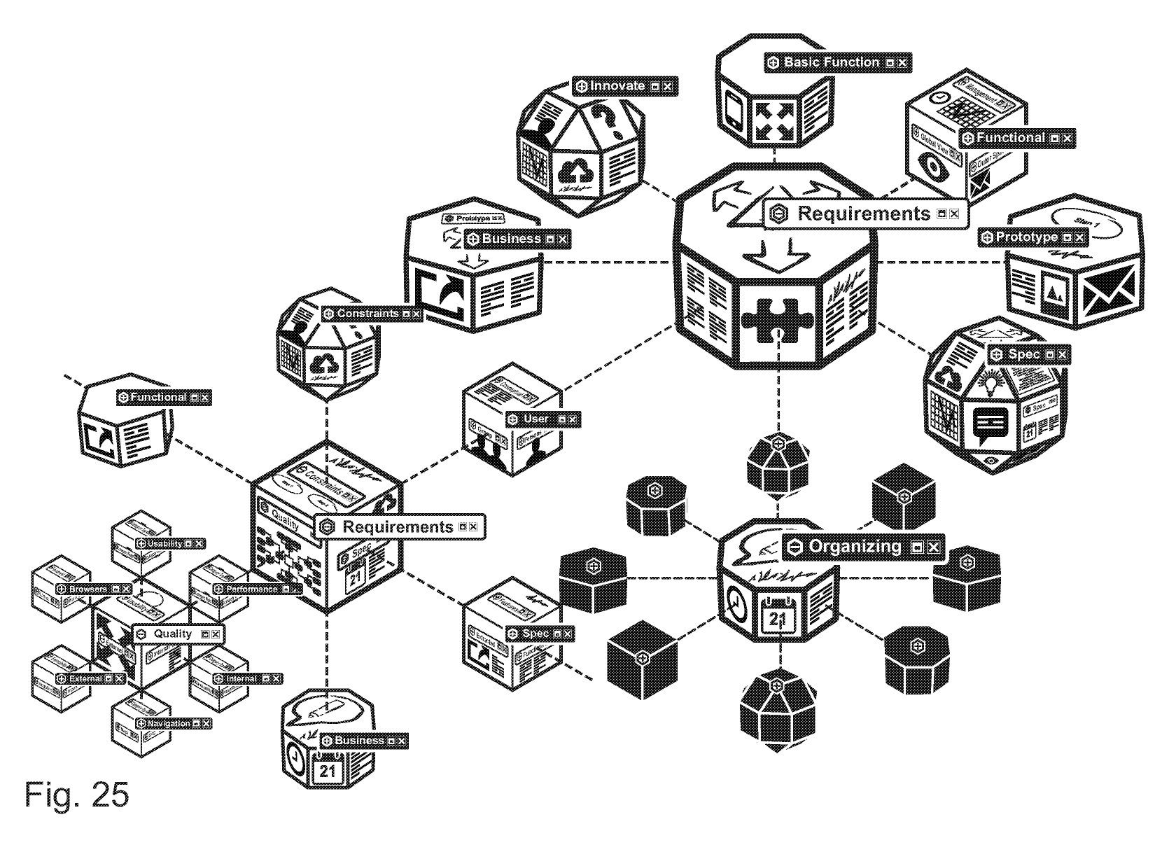

FIGS. 13-25 are screenshots illustrating use of a variety of graphical structures including not only a cube with six directions, but also polyhedra of different shapes with a varying number of spatial directions.

FIGS. 13, 17, and 21 illustrate inside (first-person) views of exemplary polyhedra (a hexagonal prism, an octagonal prism, and a rhombicuboctahedron, respectively) for organizing information in accordance with one or more embodiments. Each polyhedron comprises a concept, with information on faces being subcomponents/subconcepts and supporting information. Users can relate subcomponents of a concept and needed supporting information to corresponding directions, which correspond to faces of the polyhedra. The process of relating faces with directions is generally intuitive for people. Each of the faces of a polyhedron can be further decomposed and become a new polyhedron of the same or different shape to provide a way to describe the concept in more detail.

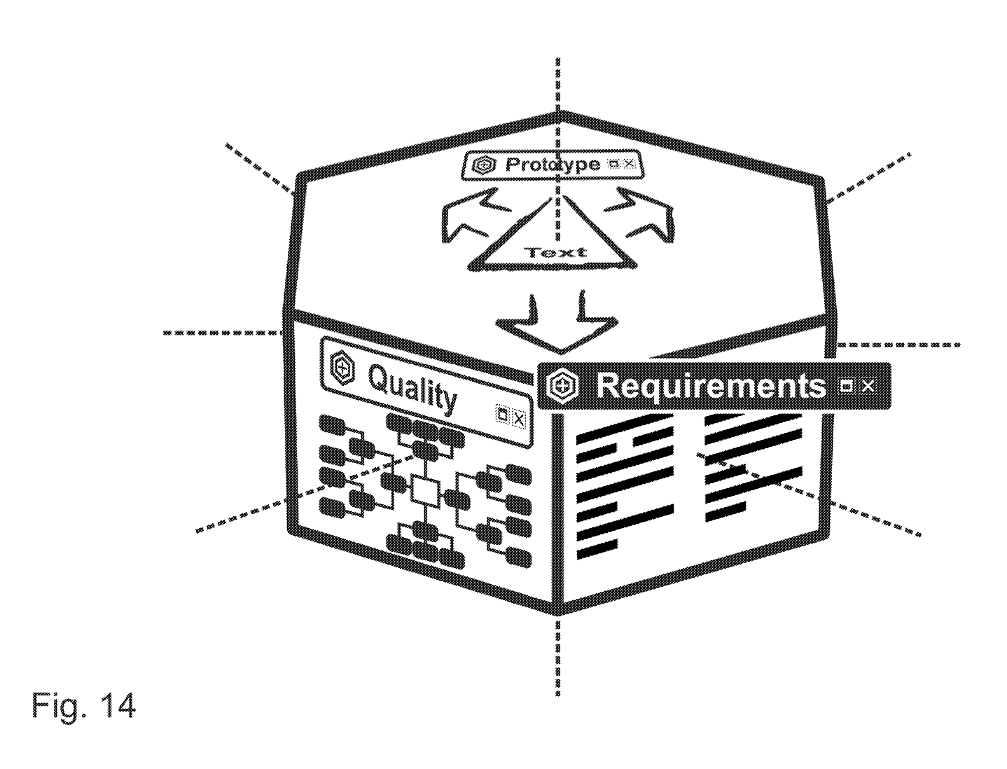

Alternatively, users can place supporting info for subcomponents on outside faces of the polyhedra as shown, e.g., in FIGS. 14, 18, 22.

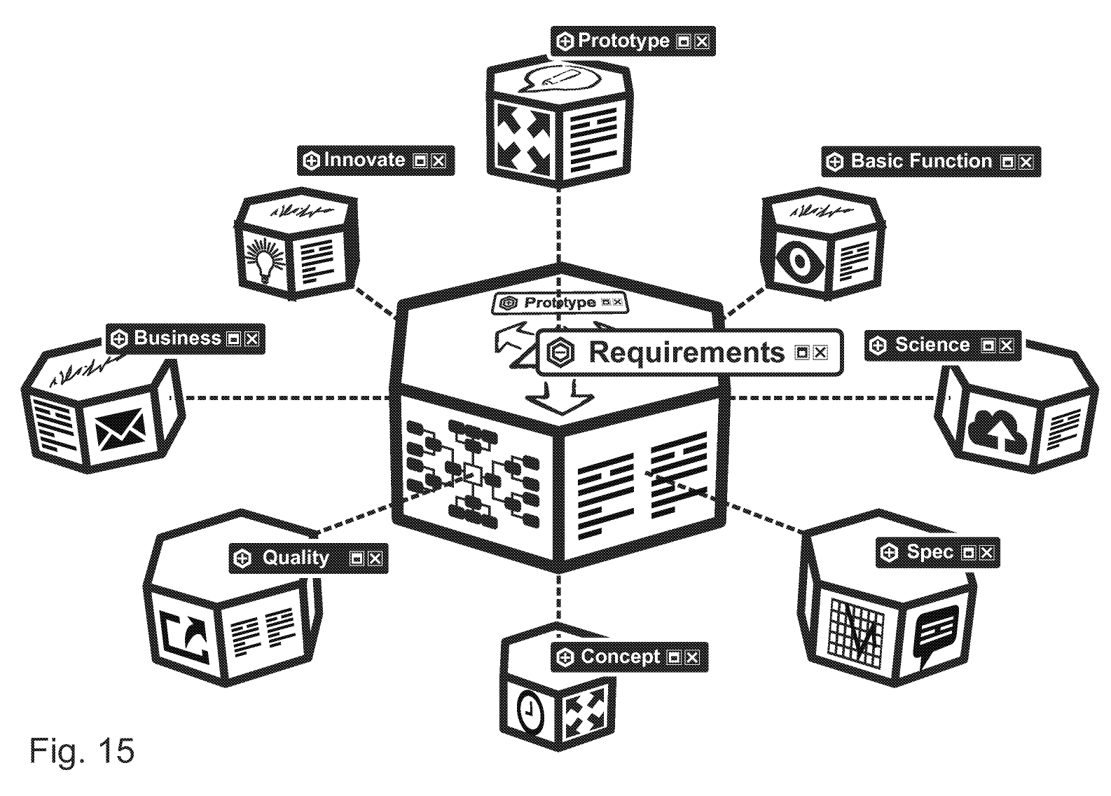

FIGS. 15, 16, 19, 20, 23-25 show outside (third-person) views of a network of resulting polyhedra structures, depicted as a fractal polyhedra structure. In order not to lose one of the directions for further use, the polyhedra are shown in such a way that each polyhedron of the next level (child polyhedron) is shown smaller in size and detached from the parent polyhedron. This view provides unique visibility and access to all the information as well as is a good resemblance of what people actually imagine if they decompose each polyhedron (create child ones) and locate them along the direction lines perpendicular to the faces. This view helps to further explore the structure created in the major (inside first-person) view, or can serve as an alternative way to create it. Furthermore, it provides a good way to get away from the details and get a more global perspective of the system or field under study.

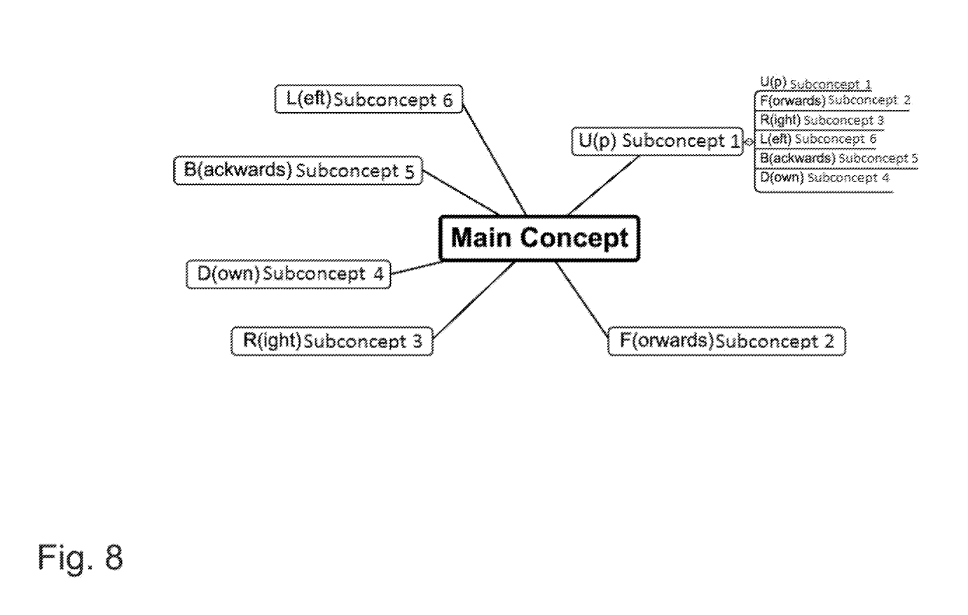

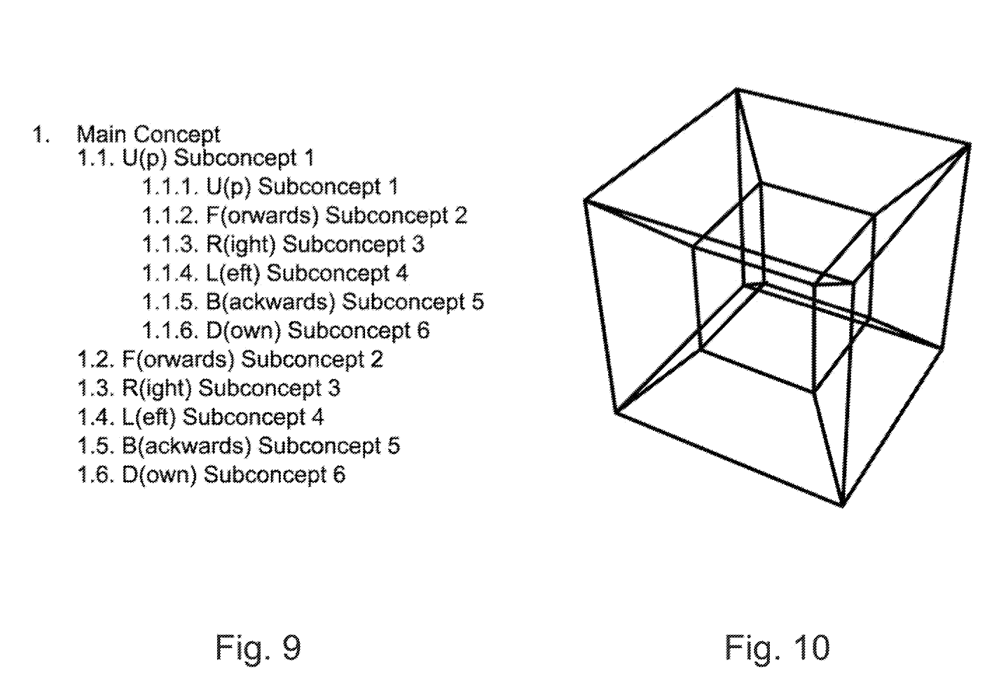

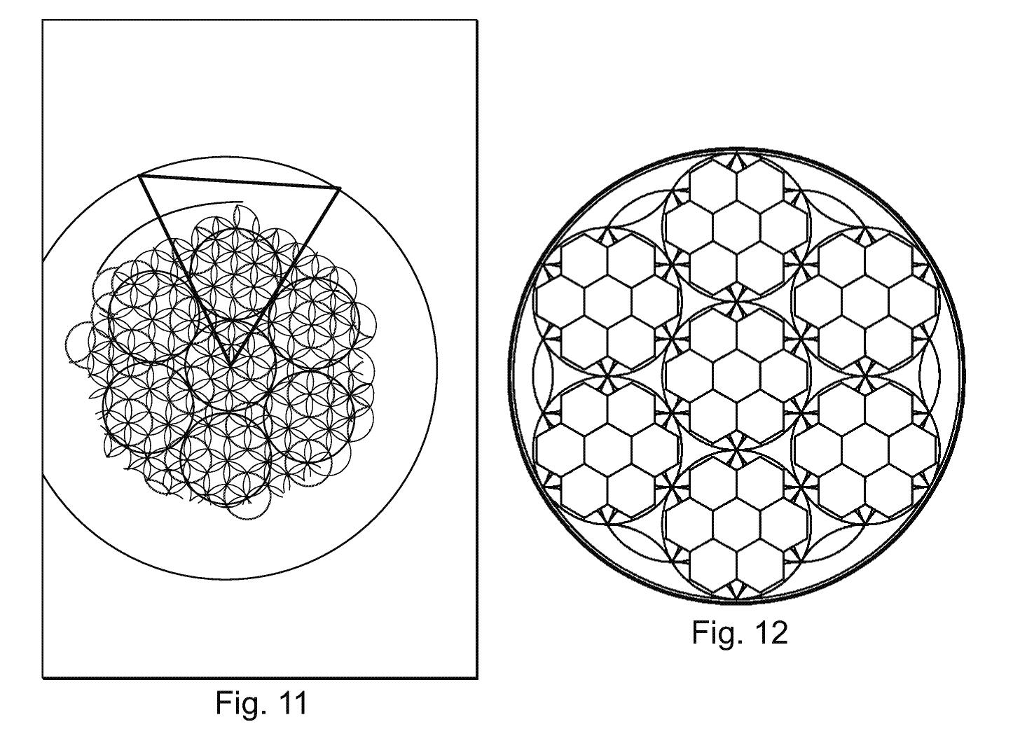

A number of other supporting or substitute views can be also be used. As users become more familiar with the data organization techniques described herein, they can use other means and user interfaces with some limitations imposed (related to storing data about directions, e.g., six directions) to get some of the benefits of the current system. Examples of such user interfaces can include (enumerated) lists/outlines (FIG. 9), hierarchical trees/mind maps (FIG. 8), hypercubes (FIG. 10), “flowers of life” (FIGS. 11 and 12), and hexagons, polygons, etc. In this case, a data structure is provided for storing the needed information in the right way to obtain the major benefits that relate to the method.

A concept or info network can thus be created with spatial relationships serving as a basis to aid users in storing large amounts of various implicit associations and relationships, as well as some explicit ones. This resulting concept or info network is very easy to remember for the users who created it.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method for graphically organizing information on a user computer device, comprising the steps of:
(a) displaying a graphical structure to a user on a graphical user interface of the user computer device, said graphical structure including a plurality of sides;
(b) enabling the user to navigate around the graphical structure using the graphical user interface and to enter one or more subcomponents of said information in at least one of a plurality of sides of the graphical structure such that the subcomponents of information have specified spatial relationships to each other in a given set directions in the graphical structure;
(c) enabling the user to decompose at least one subcomponent of information in one of the sides of the graphical structure into an additional graphical structure such that further subcomponents of said at least one subcomponent of information are displayed in each of a plurality of sides of the additional graphical structure, said further subcomponents of information having specified spatial relationships to each other in a given set directions in the additional graphical structure; and
(d) enabling the user to edit, move, or add subcomponents of information in or to the graphical structure or additional graphical structure, or modify the spatial relationships of the subcomponents or further subcomponents of the information to each other using the graphical user interface.

2. The method of claim 1, further comprising adding supporting information to one or more subcomponents displayed in the graphical structures.

3. The method of claim 2, wherein the supporting information comprises text, images, links, video files, sound files, or document files.

4. The method of claim 1, wherein the subcomponents of information are added to and shown on inside faces of the graphical structures.

5. The method of claim 1, wherein the subcomponents of information are added to and shown on outside faces of the graphical structures.

6. The method of claim 1, wherein the graphical structures comprise cubes, wherein the set of directions comprise six primary directions, each corresponding to one side of the cubes, and wherein the graphical structures form a fractal cubical network.

7. The method of claim 1, wherein the graphical structures comprise polyhedra.

8. The method of claim 7, wherein the polyhedra have different shapes and a varying number of spatial directions.

9. The method of claim 8, wherein the polyhedra comprise a hexagonal prism, an octagonal prism, or a rhombicuboctahedron.

10. The method of claim 1, wherein the graphical structures comprise polygons.

11. The method of claim 1, wherein the graphical structures comprise a hexagon, a flower of life, and enumerated list, a hierarchical tree structure, a color scheme, or a hypercube.

12. The method of claim 1, wherein the graphical structure is shown larger in size than the additional graphical structure.

13. The method of claim 1, wherein the set of directions comprise six primary directions or combinations thereof, polar and azimuth angles of a spherical coordinate system, cardinal directions applied to primary planes, or clock positions and directions.

14. The method of claim 1, wherein step (b) comprises enabling the user to navigate around the graphical structure using the graphical user interface and to enter different subcomponents of said information in each of a plurality of sides of the graphical structure.

15. A computer system, comprising:
at least one processor;
memory associated with the at least one processor;
a display;
at least one input device; and
a program supported in the memory for enabling a user to graphically organize information, the program containing a plurality of instructions which, when executed by the at least one processor, cause the at least one processor to:
(a) display a graphical structure to the user on the display, said graphical structure including a plurality of sides;
(b) enable the user to navigate around the graphical structure using a graphical user interface and to enter a one or more subcomponents of said information in at least one of a plurality of sides of the graphical structure such that the subcomponents of information have specified spatial relationships to each other in a given set directions in the graphical structure;
(c) enable the user to decompose at least one subcomponent of information in one of the sides of the graphical structure into an additional graphical structure such that further subcomponents of said at least one subcomponent of information are displayed in each of a plurality of sides of the additional graphical structure, said further subcomponents of information having specified spatial relationships to each other in a given set directions in the additional graphical structure; and
(d) enable the user to edit, move, or add subcomponents of information in or to the graphical structure or additional graphical structures, or modify the spatial relationships of the subcomponents or further subcomponents of the information to each other using the graphical user interface.

16. The computer system of claim 15, wherein the program further comprises instructions for causing the processor to add supporting information to one or more subcomponents displayed in the graphical structures.

17. The computer system of claim 16, wherein the supporting information comprises text, images, links, video files, sound files, or document files.

18. The computer system of claim 15, wherein the subcomponents of information are added to and shown on inside faces of the graphical structures.

19. The computer system of claim 15, wherein the subcomponents of information are added to and shown on outside faces of the graphical structures.

20. The computer system of claim 15, wherein the graphical structures comprise cubes, wherein the set of directions comprise six primary directions, each corresponding to one side of the cubes, and wherein the graphical structures form a fractal cubical network.

21. The computer system of claim 15, wherein the graphical structures comprise polyhedra.

22. The computer system of claim 21, wherein the polyhedra have different shapes and a varying number of spatial directions.

23. The computer system of claim 22, wherein the polyhedra comprise a hexagonal prism, an octagonal prism, or a rhombicuboctahedron.

24. The computer system of claim 15, wherein the graphical structures comprise polygons.

25. The computer system of claim 15, wherein the graphical structures comprise a hexagon, a flower of life, and enumerated list, a hierarchical tree structure, a color scheme, or a hypercube.

26. The computer system of claim 15, wherein the graphical structure is shown larger in size than the additional graphical structure.

27. The computer system of claim 15, wherein the set of directions comprise six primary directions or combinations thereof, polar and azimuth angles of a spherical coordinate system, cardinal directions applied to primary planes, or clock positions and directions.

28. The computer system of claim 15, wherein (b) comprises enable the user to navigate around the graphical structure using the graphical user interface and to enter different subcomponents of said information in each of a plurality of sides of the graphical structure.
